(19) United States
(12) Patent Application Publication
(10) Pub. No.: US 2022/0417776 A1
(43) Pub. Date: Dec. 29, 2022

(54) CONFIGURATION OF CSI REFERENCE RESOURCE AND CSI TARGET RESOURCE FOR PREDICTIVE ESTIMATION OF CHANNEL STATE INFORMATION

(71) Applicant: QUALCOMM Incorporated, San Diego, CA (US)

(72) Inventors: Alexandros Manolakos, Escondido, CA (US); Chenxi Hao, Beijing (CN); Yu Zhang, San Diego, CA (US); June Namgoong, San Diego, CA (US); Krishna Kiran Mukkavilli, San Diego, CA (US); Joseph Binamira Soriaga, San Diego, CA (US); Peter Gaal, San Diego, CA (US)

(21) Appl. No.: 17/754,547

(22) PCT Filed: Oct. 17, 2019
(86) PCT No.: PCT/CN2019/111579

§ 371 Date: Apr. 5, 2022

(51) Int. Cl. H04W 24/10; H04L 5/00

(52) U.S. Cl. CPC H04W 24/10; H04L 5/0048

(57) ABSTRACT

This disclosure provides systems, methods, and apparatus, including computer programs encoded on computer storage media, for wireless communication. In one or more aspects, a user equipment (UE) is configured to transmit capability information of the UE for channel state information (CSI) reporting. The UE is further configured to receive, from a base station, configuration information for the CSI reporting. The configuration information indicates a CSI reference resource including a plurality of a first type of time units for CSI reference signal (CSI RS) monitoring, a CSI target resource including one or more of a second type of time units for which channel state information is to be estimated, or both. The CSI target resource is later in time as compared to the CSI reference resource. Other aspects and features are also claimed and described.

### TECHNICAL FIELD

Aspects of the technology discussed below relate generally to wireless communication systems, and more particularly, but not by way of limitation, to configuring a channel state information (CSI) reference resource, a CSI target resource, or both. The discussed techniques can help to enable reliable high data rates with improved mobility support for overall improved system performance and user experience.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations (BS, nodeBs, eNodeBs or gNodeBs) that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Channel state information (CSI) refers to channel properties of a communication link. CSI indicates how a signal propagates from a transmitter to a receiver. In a wireless communications system, channel conditions may vary based on several factors, including distance between transmitter and receiver, interfering signals, blockages/obstructions, and the like. In such communications systems, a UE may receive a reference signal (RS) (e.g. a CSI RS) prior to or at a designated time slot and the UE may calculate CSI through channel estimation using a single received CSI RS. The UE then may report the CSI to the base station by transmitting a CSI report message. A base station can use the CSI from the UE to adapt transmissions to current channel condition.

While CSI feedback from a UE to a base station enables the base station to adapt transmission to wireless channel conditions, timing issues may be experienced. For example, there can exist a time gap between when the UE may receive a CSI RS to estimate CSI and the time when the base station may transmit data to the UE using the CSI report from the UE. Also, when channel conditions vary (e.g. when the UE is moving with respect to the base station or when interference conditions are changing), the CSI may be stale at the time the base station may transmit data. Accordingly, in such circumstances, the base station is unable to receive or determine reliable information of the current channel condition to adapt transmission(s) for reliable communication, such as reliable communication with high data rates.

### BRIEF SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes transmitting, by a user equipment (UE), capability information of the UE for channel state information (CSI) reporting. The method further includes receiving, by the UE from a base station, configuration information for the CSI reporting. The configuration information indicates a CSI reference resource including a plurality of a first type of time units for CSI reference signal (CSI RS) monitoring, a CSI target resource including one or more of a second type of time units for which channel state information is to be estimated, or both. The CSI target resource can be spaced apart in time (e.g., earlier and/or later in time) compared to the CSI reference resource.

In an additional aspect of the disclosure, an apparatus configured wireless communication includes means for transmitting, by a user equipment (UE), capability information of the UE for channel state information (CSI) reporting. The apparatus further includes means for receiving, by the UE from a base station, configuration information for the CSI reporting. The configuration information indicates a CSI reference resource including a plurality of a first type of time units for CSI reference signal (CSI RS) monitoring, a CSI target resource including one or more of a second type of time units for which channel state information is to be estimated, or both. The CSI target resource is later in time compared to the CSI reference resource.

In an additional aspect of the disclosure, a non-transitory computer-readable medium having program code recorded thereon. The program code further includes code to initiate, by a user equipment (UE), transmission of capability information of the UE for channel state information (CSI) reporting, and receive, by the UE from a base station, configuration information for the CSI reporting. The configuration information indicates a CSI reference resource including a plurality of a first type of time units for CSI reference signal (CSI RS) monitoring, a CSI target resource including one or more of a second type of time units for which channel state information is to be estimated, or both. The CSI target resource is later in time compared to the CSI reference resource.

In an additional aspect of the disclosure, an apparatus configured for wireless communication is disclosed. The apparatus includes at least one processor, and a memory coupled to the processor. The processor is configured to perform operations including transmitting, by a user equipment (UE), capability information of the UE for channel state information (CSI) reporting, and receiving, by the UE from a base station, configuration information for the CSI reporting. The configuration information indicates a CSI reference resource including a plurality of a first type of time units for CSI reference signal (CSI RS) monitoring, a CSI target resource including one or more of a second type of time units for which channel state information is to be estimated, or both. The CSI target resource is later in time compared to the CSI reference resource.

In an additional aspect of the disclosure, an apparatus includes an interface configured for wireless communication. The apparatus also includes a processor system coupled to the interface and configured to initiate, by a user equipment (UE), transmission of capability information of the UE for channel state information (CSI) reporting, and receive, by the UE from a base station, configuration information for the CSI reporting. The configuration information indicates a CSI reference resource including a plurality of a first type of time units for CSI reference signal (CSI RS) monitoring, a CSI target resource including one or more of a second type of time units for which channel state information is to be estimated, or both. The CSI target resource is later in time compared to the CSI reference resource.

In an additional aspect of the disclosure, a method of wireless communication includes determining, by a user equipment (UE), a duration of a channel state information (CSI) reference resource. The CSI reference resource includes a plurality of a first type of time units for CSI reference signal (CSI RS) monitoring. The method further includes determining, by the UE, whether to omit transmission of a CSI report indicating channel state information of a CSI target resource. Determining whether to transmit or omit transmission may be based on a number of CSI reference signal (CSI RS) occasions detected during the duration of the CSI reference resource. The CSI target resource includes one or more of a second type of time units for which channel state information is to be estimated, the CSI target resource is later in time as compared to the CSI reference resource, and the transmission of the CSI report is between the CSI reference resource and the CSI target resource in time.

In an additional aspect of the disclosure, an apparatus configured wireless communication includes means for determining, by a user equipment (UE), a duration of a channel state information (CSI) reference resource. The CSI reference resource includes a plurality of a first type of time units for CSI reference signal (CSI RS) monitoring. The apparatus further includes means for determining, by the UE, whether to omit transmission of a CSI report indicating channel state information of a CSI target resource based on a number of CSI reference signal (CSI RS) occasions detected during the duration of the CSI reference resource. The CSI target resource includes one or more of a second type of time units for which channel state information is to be estimated, the CSI target resource is later in time as compared to the CSI reference resource, and the transmission of the CSI report is between the CSI reference resource and the CSI target resource in time.

In an additional aspect of the disclosure, a non-transitory computer-readable medium having program code recorded thereon. The program code further includes code to determine, by a user equipment (UE), a duration of a channel state information (CSI) reference resource. The CSI reference resource includes a plurality of a first type of time units for CSI reference signal (CSI RS) monitoring. The program code further includes code to determine, by the UE, whether to omit transmission of a CSI report indicating channel state information of a CSI target resource based on a number of CSI reference signal (CSI RS) occasions detected during the duration of the CSI reference resource. The CSI target resource includes one or more of a second type of time units for which channel state information is to be estimated, the CSI target resource is later in time as compared to the CSI reference resource, and the transmission of the CSI report is between the CSI reference resource and the CSI target resource in time.

In an additional aspect of the disclosure, an apparatus configured for wireless communication is disclosed. The apparatus includes at least one processor, and a memory coupled to the processor. The processor is configured to perform operations including determining, by a user equipment (UE), a duration of a channel state information (CSI) reference resource. The CSI reference resource includes a plurality of a first type of time units for CSI reference signal (CSI RS) monitoring. The processor is further configured to perform the operations including determining, by the UE, whether to omit transmission of a CSI report indicating channel state information of a CSI target resource based on a number of CSI reference signal (CSI RS) occasions detected during the duration of the CSI reference resource. The CSI target resource includes one or more of a second type of time units for which channel state information is to be estimated, the CSI target resource is later in time as compared to the CSI reference resource, and the transmission of the CSI report is between the CSI reference resource and the CSI target resource in time.

In an additional aspect of the disclosure, an apparatus an interface configured for wireless communication. The apparatus also includes a processor system coupled to the interface and configured to determine, by a user equipment (UE), a duration of a channel state information (CSI) reference resource. The CSI reference resource includes a plurality of a first type of time units for CSI reference signal (CSI RS) monitoring. The processor system is further configured to determine, by the UE, whether to omit transmission of a CSI report indicating channel state information of a CSI target resource based on a number of CSI reference signal (CSI RS) occasions detected during the duration of the CSI reference resource. The CSI target resource includes one or more of a second type of time units for which channel state information is to be estimated, the CSI target resource is later in time as compared to the CSI reference resource, and the transmission of the CSI report is between the CSI reference resource and the CSI target resource in time.

In an additional aspect of the disclosure, a method of wireless communication receiving, by a base station, capability information of a user equipment (UE) for channel state information (CSI) reporting. The method further includes determining, by the base station based on the capability information, a CSI reference resource including a plurality of a first type of time units for CSI reference signal (CSI RS) monitoring, a CSI target resource including one or more of a second type of time units for which channel state information is to be estimated, or both. The CSI target resource is later in time as compared to the CSI reference resource. The method further includes transmitting, by the base station, configuration information for the CSI reporting, the configuration information indicating the CSI reference resource, the CSI target resource, or both, transmitting, by the base station, one or more CSI RS in the CSI reference resource, and receiving, by the base station from the UE, a CSI report indicating the channel state information for the CSI target resource.

In an additional aspect of the disclosure, an apparatus configured wireless communication includes means for receiving, by a base station, capability information of a user equipment (UE) for channel state information (CSI) reporting. The apparatus further includes means for determining, by the base station based on the capability information, a CSI reference resource including a plurality of a first type of time units for CSI reference signal (CSI RS) monitoring, a CSI target resource including one or more of a second type of time units for which channel state information is to be estimated, or both. The CSI target resource is later in time as compared to the CSI reference resource. The apparatus also includes means for transmitting, by the base station, configuration information for the CSI reporting, the configuration information indicating the CSI reference resource, the CSI target resource, or both, means for transmitting, by the base station, one or more CSI RS in the CSI reference resource, and means for receiving, by the base station from the UE, a CSI report indicating the channel state information for the CSI target resource.

In an additional aspect of the disclosure, a non-transitory computer-readable medium having program code recorded thereon. The program code further includes code to receive, by a base station, capability information of a user equipment (UE) for channel state information (CSI) reporting, and determine, by the base station based on the capability information, a CSI reference resource including a plurality of a first type of time units for CSI reference signal (CSI RS) monitoring, a CSI target resource including one or more of a second type of time units for which channel state information is to be estimated, or both. The CSI target resource is later in time as compared to the CSI reference resource. The program code also includes code to initiate transmission, by the base station, configuration information for the CSI reporting, the configuration information indicating the CSI reference resource, the CSI target resource, or both, initiate transmission, by the base station, one or more CSI RS in the CSI reference resource, and receive, by the base station from the UE, a CSI report indicating the channel state information for the CSI target resource.

In an additional aspect of the disclosure, an apparatus configured for wireless communication is disclosed. The apparatus includes at least one processor, and a memory coupled to the processor. The processor is configured to perform operations including receiving, by a base station, capability information of a user equipment (UE) for channel state information (CSI) reporting, and determining, by the base station based on the capability information, a CSI reference resource including a plurality of a first type of time units for CSI reference signal (CSI RS) monitoring, a CSI target resource including one or more of a second type of time units for which channel state information is to be estimated, or both. The CSI target resource is later in time as compared to the CSI reference resource. The processor is further configured to perform operations including initiating transmission, by the base station, configuration information for the CSI reporting, the configuration information indicating the CSI reference resource, the CSI target resource, or both, initiating transmission, by the base station, one or more CSI RS in the CSI reference resource, and receiving, by the base station from the UE, a CSI report indicating the channel state information for the CSI target resource

In an additional aspect of the disclosure, an apparatus an interface configured for wireless communication. The apparatus also includes a processor system coupled to the interface and configured to receive, by a base station, capability information of a user equipment (UE) for channel state information (CSI) reporting, and determine, by the base station based on the capability information, a CSI reference resource including a plurality of a first type of time units for CSI reference signal (CSI RS) monitoring, a CSI target resource including one or more of a second type of time units for which channel state information is to be estimated, or both. The CSI target resource is later in time as compared to the CSI reference resource. The processor system is further configured to initiate transmission, by the base station, configuration information for the CSI reporting, the configuration information indicating the CSI reference resource, the CSI target resource, or both, initiate transmission, by the base station, one or more CSI RS in the CSI reference resource, and receive, by the base station from the UE, a CSI report indicating the channel state information for the CSI target resource.

Other aspects, features, and implementations of the present disclosure will become apparent to those of ordinary skill in the art, upon reviewing the following description of specific, illustrative implementations of the present disclosure in conjunction with the accompanying figures. While features and aspects of the present disclosure may be discussed relative to certain implementations and figures below, all implementations of the present disclosure can include one or more of the advantageous features discussed herein. In other words, while one or more implementation may be discussed as having certain advantageous features, one or more of such features may also be used in accordance with the various implementations discussed herein. In similar fashion, while implementations may be discussed below as device, system, or method implementations, such implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some aspects.

FIG. 2 is a block diagram conceptually illustrating a design of a base station and a UE configured according to some aspects.

FIG. 3 is a block diagram illustrating a wireless communication system (with a UE and BS) with communications that utilize a CSI reference resource, a CSI target resource, or both, for predictive estimation of CSI in accordance with some aspects of the present disclosure.

FIG. 4A is a diagram illustrating an example of a CSI reference resource, a CSI target resource, and a CSI report in accordance with some aspects of the present disclosure.

FIG. 4B and FIG. 4C are diagrams illustrating examples CSI RS occasions within a CSI reference resource in accordance with some aspects of the present disclosure.

FIG. 5 is a flow diagram illustrating example blocks executed by a UE according to some aspects.

FIG. 6 is a flow diagram illustrating example blocks executed by a UE according to some aspects.

FIG. 7 is a flow diagram illustrating example blocks executed by a UE according to some aspects.

FIG. 8 is a flow diagram illustrating example blocks executed by a base station according to some aspects.

FIG. 9 is a block diagram conceptually illustrating an example design of a UE according to some aspects.

FIG. 10 is a block diagram conceptually illustrating an example design of a base station according to some aspects.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In the present disclosure, various aspects and techniques regarding CSI estimation, such as predictive CSI estimation, and reporting are disclosed. The various aspects and techniques described herein may include or relate to how to configure a CSI reference resource for CSI RS monitoring and a CSI target resource for which channel state information is to be estimated. For example, as described further herein, a UE may transmit capability information of the UE for channel state information (CSI) reporting. The UE may receive, from a base station, configuration information for the CSI reporting. The configuration information may indicate a CSI reference resource including a plurality of a first type of time units for CSI reference signal (CSI RS) monitoring, a CSI target resource including one or more of a second type of time units for which channel state information is to be estimated, or both. Stated in another manner, the configuration information may indicate one or more of a CSI reference resource (including a plurality of a first type of time units for CSI RS monitoring) or a CSI target resource (including one or more of a second type of time units for which channel state information is to be estimated). The CSI target resource is later in time compared to the CSI reference resource. The UE may determine a duration of the CSI reference resource. The UE may determine whether to omit transmission of the CSI report indicating channel state information of a CSI target resource based on a number of CSI reference signal (CSI RS) occasions detected during the duration of the CSI reference resource.

As described further below, UEs may communicate with BSs by sending a variety of reports and transmissions. These reports and transmissions can be based on several contingencies or factors. For example, based on a determination to transmit the CSI report, the UE may generate the CSI report based on one or more CSI occasions and may generate the CSI report as a predictive report for one or more of the second type of time units. By generating the predictive CSI report, the UE may account for channel state variations (e.g. when the UE is moving with respect to the base station or when interference conditions are changing). Accordingly, the base station may use or rely on the CSI report because the CSI is predictive and accounts for the channel state variations. Accordingly, the base station is able to receive or determine reliable information of the current channel condition to adapt transmission(s) for reliable communication, such as reliable communication with high data rates.

This disclosure relates generally to providing or participating in communication as between two or more wireless devices in one or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as GSM. 3GPP defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with Universal Terrestrial Radio Access Networks (UTRANs) in the case of a UMTS/GSM network. An operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to exemplary LTE implementations or in an LTE-centric way, and LTE terminology may be used as illustrative examples in portions of the description below; however, the description is not intended to be limited to LTE applications. Indeed, the present disclosure is concerned with shared access to wireless spectrum between networks using different radio access technologies or radio air interfaces, such as those of 5G NR.

Moreover, it should be understood that, in operation, wireless communication networks adapted according to the concepts herein may operate with any combination of licensed or unlicensed spectrum depending on loading and availability. Accordingly, it will be apparent to one of skill in the art that the systems, apparatus and methods described herein may be applied to other communications systems and applications than the particular examples provided.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

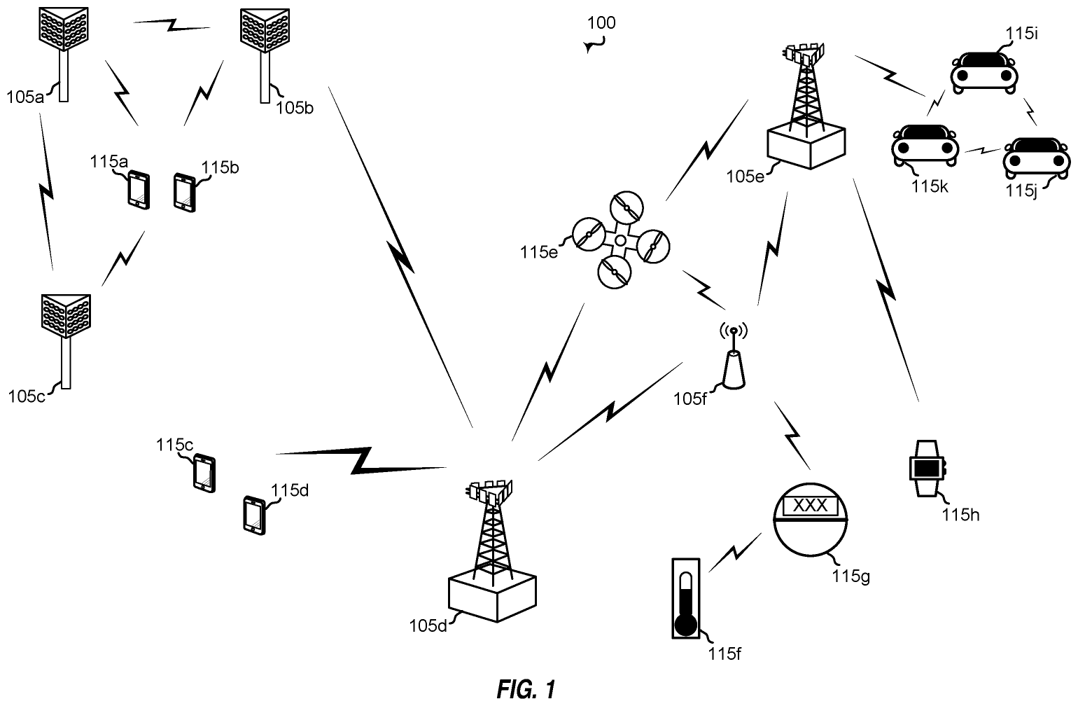

FIG. 1 shows wireless network 100 for communication according to some embodiments. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks), and may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3rd Generation Partnership Project (3GPP), such apparatus may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include embodiments of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, gaming devices, reality modification devices (e.g., extended reality (XR), augmented reality (AR), virtual reality (VR)), entertainment devices, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the embodiment illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a lightning bolt (e.g., communication link) indicates wireless transmissions between a UE and a serving base station, which is a base station designated to serve the UE on the downlink and/or uplink, or desired transmission between base stations, and backhaul transmissions between base stations. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 can support mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

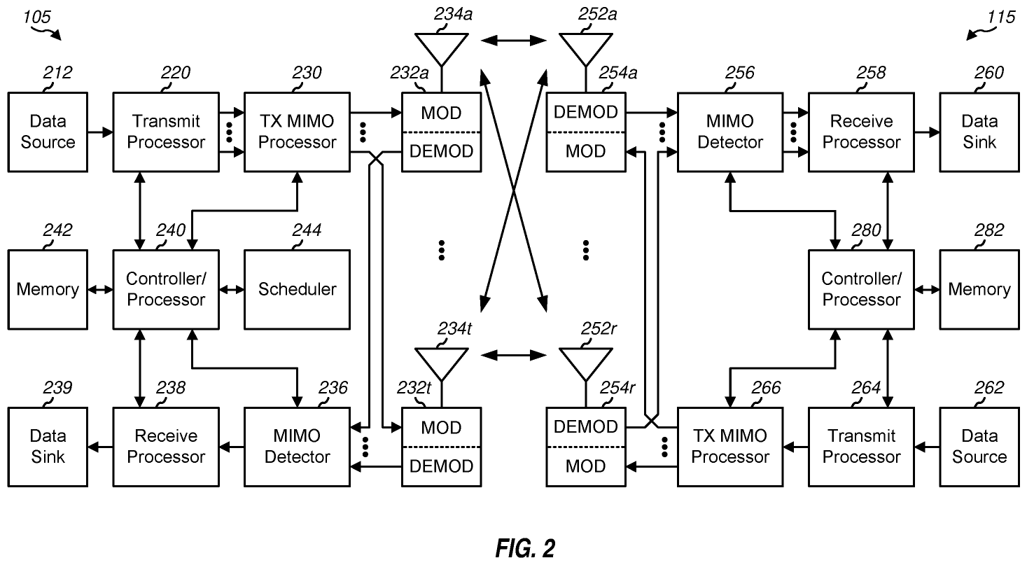

FIG. 2 shows a block diagram of a design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At the base station 105, a transmit processor 220 may receive data from a data source 212 and control information from a controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal. The symbols from the transmit processor 264 may be precoded by TX MIMO processor 266 if applicable, further processed by the modulators 254a through 254r (e.g., for SC-FDM, etc.), and transmitted to the base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

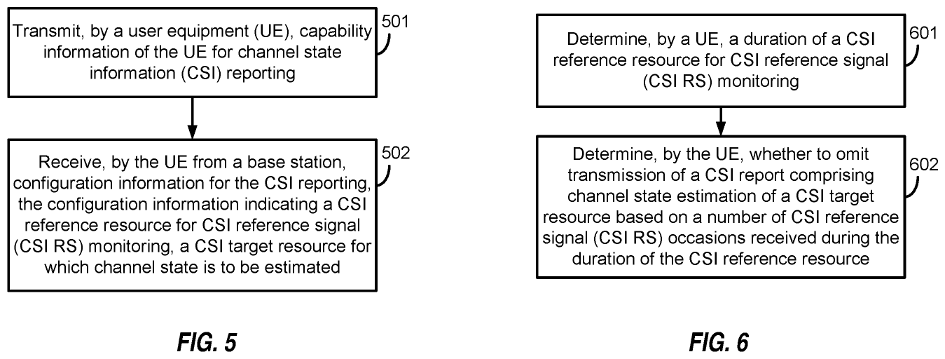

Controllers/processors 240 and 280 may direct the operation at base station 105 and UE 115, respectively. Controller/processor 240 and/or other processors and modules at base station 105 and/or controller/processor 28 and/or other processors and modules at UE 115 may perform or direct the execution of various processes for the techniques described herein, such as to perform or direct the execution illustrated in FIGS. 5-8, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

CSI enables a transmitter in wireless communication network identify the condition of wireless communication channel which enables adaptive transmission of data according to the channel condition(s). For example, in 5G new radio (NR) system, a base station (or gNodeB) may transmit a CSI RS and a UE may report a CSI by monitoring and measuring the CSI RS. In some implementations, the base station may configure the UE for monitoring and/or reporting. Alternatively, monitoring and/or reporting by the UE may be predetermined (e.g., stored or programmed settings at the UE), such as settings based on a wireless standard.

The UE may perform CSI estimation through channel estimation using the received CSI RS, and the UE may transmit a CSI report to the base station representative of or indicating the estimated CSI. The base station may use the CSI to adapt its transmission to the UE. It is noted that a time gap (e.g., a delay) exists between the moment when the base station transmits the CSI RS and the UE receives the CSI RS and a time gap between the transmission of a CSI report by the UE and the moment when the base station adapts transmission to the UE. In situations when channel conditions are varying, such as when the UE is moving at a high speed, the channel condition between the UE and the base station may change in a short time period, and an estimated CSI from the UE may be already stale for the base station to use to adapt its transmission. When this occurs, the data transmission may be based on an outdated CSI.

To account for changing channel conditions and the potential for a stale estimated CSI, the base station may send on or more CSI RSs, such as multiple CSI RSs at different times, during a time period. For example, the time period may include a time period, such as a bounded time period having a set duration (e.g., a start time and an end time). When multiple CSI RSs are received by the UE, the UE may perform predictive channel state estimation for the future time using the multiple CSI RSs, instead of estimating channel state information for the time when the UE receives the CSI RS. An illustrative, non-limiting example of techniques and apparatuses for downlink precoding configuration for user equipment mobility scenarios is illustrated and described in PCT patent application serial number PCT/CN2019/100929 entitled “DOWNLINK PRECODING CONFIGURATION FOR USER EQUIPMENT MOBILITY SCENARIOS,” filed Aug. 16, 2019, the disclosure of which is incorporated herein by reference. Also, an illustrative, non-limiting example of techniques and apparatuses for a user equipment that is to report channel state and Doppler frequency information to a base station is illustrated and described in PCT patent application serial number PCT/CN2019/095750 entitled “SYSTEM AND METHOD FOR REPORTING CHANNEL STATE AND DOPPLER FREQUENCY INFORMATION,” filed Jul. 12, 2019, the disclosure of which is incorporated herein by reference. For purposes of the present disclosure, downlink precoding configuration and report channel state and Doppler frequency information for predictive channel state information estimation may be accomplished according to the above-referenced PCT patent applications.

In some implementations, several radio resources may be configured to enable predictive channel state information estimation. Sample deployments and use cases can include CSI reference resource for CSI RS monitoring and CSI target resource for which channel state information is to be estimated for predictive channel state information estimation. The CSI target resource may be later in time as compared to the CSI reference resource. For example, base station 105 may transmit CSI RS at one or more CSI RS occasions during the CSI reference resource. UE 115 may monitor the CSI RS from base station 105 and estimate future CSI for the CSI target resource. Then UE 115 may send a CSI report to base station 105 indicating the estimated future CSI of the CSI target resource.

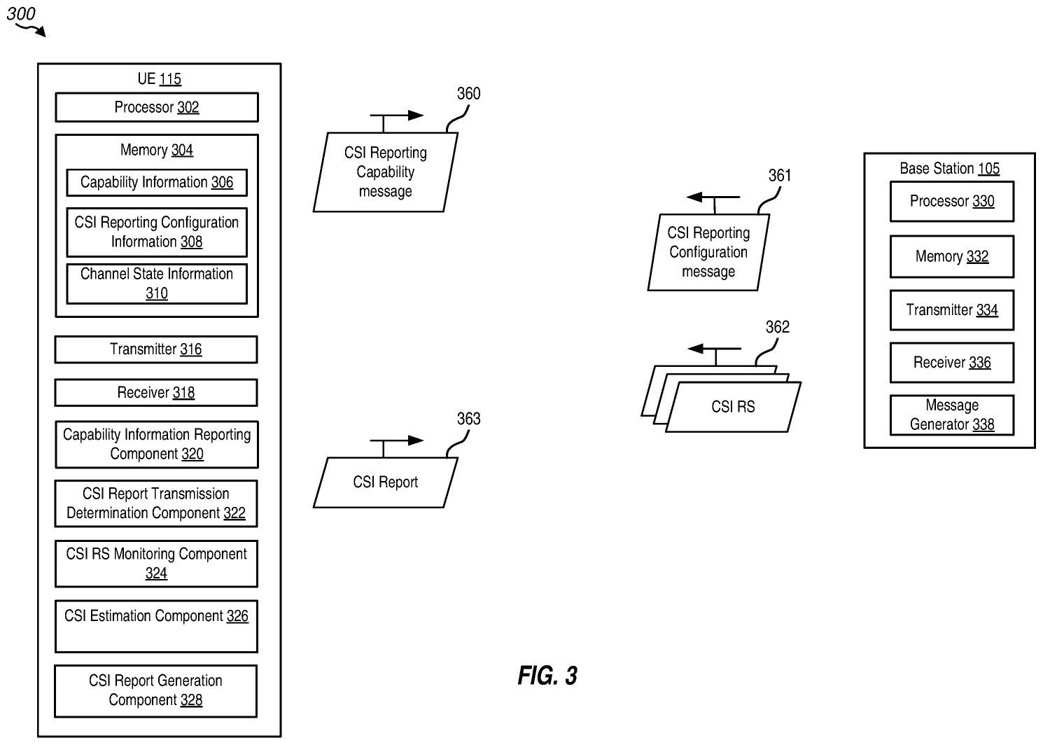

FIG. 3 is a block diagram of an example wireless communications system 300 to utilize a CSI reference resource, a CSI target resource, or both, for predictive estimation of CSI. In some examples, wireless communications system 300 may implement aspects of wireless communication system 100. For example, wireless communications system 300 may include UE 115 and base station 105. Although one UE and one base station are illustrated, in other implementations, wireless communications system 300 may include multiple UEs 115, a single base station 105 or more than two base stations 105, or both.

UE 115 can include a variety of components (e.g., structural, hardware components) used for carrying out one or more functions described herein. For example, these components can include a processor 302, a memory 304, a transmitter 316, a receiver 318, a capability information reporting component 320, a CSI report transmission determination component 322, a CSI RS monitoring component 324, a CSI estimation component 326 and a CSI report generation component 328. Processor 302 may be configured to execute instructions stored at memory 304 to perform the operations described herein. In some implementations, processor 302 includes or corresponds to controller/processor 280, and memory 304 includes or corresponds to memory 282. In addition to the instructions stored at memory 304, memory 304 may be configured to store capability information 306, CSI reporting configuration information 308 and channel state information 310, as further described herein.

The capability information 306 may include various capability information regarding CSI reporting, especially for predictive CSI estimation. In an aspect, the capability information may include a minimum duration of a CSI reference resource for CSI RS monitoring, a maximum time offset between the CSI reference resource and the CSI target resource for which channel state information is to be estimated, a minimum time offset between the CSI reference resource and transmission of a CSI report, or combination thereof, as illustrative, non-limiting examples.

CSI reporting configuration information 308 may include information that UE 115 may receive from base station 105 for CSI reporting. UE 115 may receive the CSI reporting configuration from CSI reporting configuration message 361 that is transmitted by base station 105. The CSI reporting configuration information may indicate the CSI reference resource including a plurality of a first type of time units for CSI RS monitoring, the CSI target resource including one or more of a second type of time units for which channel state information is to be estimated, or both, as illustrative, non-limiting examples. UE 115 may store channel state information 310 by monitoring CSI RS 362 and perform channel state information estimation.

Transmitter 316 is configured to transmit data to one or more other devices, and receiver 318 is configured to receive data from one or more other devices. For example, transmitter 316 may transmit data, and receiver 318 may receive data, via a wireless network. In some implementations, transmitter 316 and receiver 318 may be replaced with a transceiver. Additionally, or alternatively, transmitter 316, receiver 318, or both may include or correspond to one or more components of UE 115 described with reference to FIG. 2.

Capability information reporting component 320 is configured to send CSI reporting capability message 360 indicating UE's capability related to predictive CSI estimation to base station 105. CSI report transmission determination component 322 is configured to determine whether to omit transmission of (or to transmit) the CSI report indicating channel state information of the CSI target resource based on a number of CSI reference signal (CSI RS) occasions received during the duration of the CSI reference resource. CSI RS monitoring component 324 is configured to monitor CSI RS 362 in order to perform channel state information estimation by CSI estimation component 326. CSI report generation component 328 is configured to generate CSI indicating the one or more channel state information for the CSI target resource.

Base station 105 includes a processor 330, a memory 332, a transmitter 334, a receiver 336, and a message generator 338. Processor 330 may be configured to execute instructions stored at memory 332 to perform the operations described herein. In some implementations, processor 330 includes or corresponds to controller/processor 240, and memory 332 includes or corresponds to memory 242.

Transmitter 334 is configured to transmit data to one or more other devices, and receiver 336 is configured to receive data from one or more other devices. For example, transmitter 334 may transmit data, and receiver 336 may receive data, via a wireless network. In some implementations, transmitter 334 and receiver 336 may be replaced with a transceiver. Additionally, or alternatively, transmitter 334, receiver, 336, or both may include or correspond to one or more components of base station 105 described with reference to FIG. 2.

Message generator 338 is configured to generate one or more messages, such as CSI reporting configuration message 361. In some implementations, CSI reporting configuration message 361 may be a RRC message.

CSI reporting configuration message 361 may include a variety of timing information. For example, it can include configuration information indicating the CSI reference resource including a plurality of a first type of time units for CSI reference signal (CSI RS) monitoring, the CSI target resource including one or more of a second type of time units for which channel state information is to be estimated, or both. The CSI target resource can be later in time compared to the CSI reference resource. The first type of time unit may be a unit defined in radio frame structure (e.g., such as a collection of OFDM symbols, slot, mini slot, subframe or radio frame). Alternatively, or additionally, the first type of time unit may be a time measuring unit (e.g., such as a microsecond or a millisecond). The second type of time unit may be a unit defined in radio frame structure (e.g., such as a collection of OFDM symbols, slot, mini slot, subframe or radio frame). Alternatively, or additionally, the second type of time unit may be a time measuring unit (e.g., such as a microsecond or a millisecond). In an aspect, the first type of time unit and the second type of time unit may be the same. In another aspect, the first type of time unit and the second type of time unit may be different. In yet another aspect, the plurality of the first type of time units may include a plurality of consecutive slots in the time domain.

Additionally, or alternatively, the configuration information in CSI reporting configuration message 361 may indicate the CSI reference resource and may further indicate a duration of the CSI reference resource. In another aspect, the configuration information in CSI reporting configuration message 361 may indicate the CSI reference resource and may further indicate a time offset between the CSI reference resource and transmission of the CSI report. In yet another aspect, the configuration information in CSI reporting configuration message 361 may indicate the CSI reference resource and further indicate a time offset between the CSI reference resource and a radio frame boundary.

In some implementations, the configuration information in CSI reporting configuration message 361 may also indicate a number of CSI-RS occasions to be used to for the channel state information estimation. The number of CSI-RS occasions may include a single occasion or multiple occasions.

In some implementations, the configuration information in CSI reporting configuration message 361 may indicate the CSI target resource and may further indicate a duration of the CSI target resource. In another implementation, the configuration information in CSI reporting configuration message 361 may indicate the CSI target resource and may further indicate a time offset between the CSI reference resources and the CSI target resource. In some implementations, the configuration information in CSI reporting configuration message 361 may include a first bitmap representing the plurality of the first type of time units for the CSI reference resource, a second bit map representing one or more of the second type of time units for the CSI target resource, or both.

During operation of system 300, UE 115 may transmit CSI reporting capability message 360. Base station 105 may receive CSI reporting capability message 360 and base station 105 may transmit CSI reporting configuration message 361 based on the capability information indicated in the CSI reporting capability message 360.

UE 115 may receive CSI reporting configuration message 361 and may determine a duration of the CSI reference resource. For example, the duration may be a bounded time period. As one example, the duration may not be an open-ended time period, such as any time prior to a particular time slot. UE 115 may further determine whether or not to omit transmission of (or to transmit) the CSI report indicating channel state information of a CSI target resource. For example, UE 115 may make such a determination, based on a number of CSI RS occasions detected during the duration of the CSI reference resource.

UE 115 may detect one or more CSI RS occasions during the duration of the CSI reference resource and may determine one or more detected CSI RS occasions. For example, UE 115 may monitor for one or more CSI RS occasions during the duration of the CSI reference resource, determine, based on monitoring for the one or more CSI RS occasions, the number of CSI RS occasions detected during the duration of the CSI reference resource, and then perform a comparison between the number of detected CSI RS occasions and a first threshold.

UE 115 may omit transmission of the CSI report based on a result of a comparison indicating that the number of the detected CSI RS occasions is less than or equal to the first threshold. In an example, if UE 115 fails to detect enough number of CSI RS occasions during the CSI reference resource to estimate future CSI for the CSI target resource, UE 115 may determine to omit transmission of the CSI report.

Alternatively, UE 115 may determine to generate and/or transmit the CSI report (e.g., 363) based on a determination that the number of CSI RS occasions during the CSI reference resource is greater that (or equal to) the first threshold. Additionally, or alternatively, UE 115 may determine whether or not one or more conditions are satisfied to determine whether or not to transmit the CSI report 363, as described further herein. In some implementations, UE 115 may determine whether or not the one or more conditions are satisfied prior to, subsequent to, concurrently with, or alternative to determining whether or not the number of CSI RS occasions (e.g., 362) detected during the CSI reference resource being greater than (or equal to) the first threshold. In some such implementations, a determination that at least one condition is not satisfied may cause UE 115 to omit the CSI report.

In another example, UE 115 may determine to transmit the CSI report (e.g., 363) for the CSI target resource based on the result of the comparison indicating that the number of detected CSI RS occasions is greater than or equal to the first threshold. UE 115 may estimate the channel state information for the one or more of the second type of time units of the CSI target resource based on at least one CSI RS occasion (e.g., 362) detected during the duration of the CSI reference resource. UE 115 may generate the CSI report (e.g., 363) indicating the one or more channel state information for the second type of time units of the CSI target resource. UE 115 may transmit CSI report 363 to base station 105.

The UE 115 may estimate future CSI for the CSI target resource based on CSI RS occasions during the CSI reference resource. To estimate a future CSI, it may be advantageous for the CSI RS occasions to be spread throughout the CSI reference resource (e.g., spaced in time). In this manner, the UE 115 may receive CSI RS at different times and observe changes of CSI RSs. In some implementations, if the CSI RS occasions are not evenly spaced, UE 115 may determine to omit CSI report 363. In an example, UE 115 may determine a number of the first type of time units (during the duration) that include a CSI RS occasion. UE may compare the number of the first type of time units that include a CSI RS to a second threshold. UE 115 may determine to omit transmission of the CSI report for the CSI target resource, if the number of the first type of time units containing the CSI RS occasions is less than a second threshold. Additionally, or alternatively, if the number of the first type of time units containing the CSI RS occasions is greater than or equal to the second threshold, UE 115 may determine to generate and/or transmit the CSI report (e.g., 363).

In another example, UE 115 may determine to omit transmission of the CSI report for the CSI target resource. As one example, omission can happen when or if a CSI RS occasion is not detected during at least one of the first type of time units of the CSI reference resource—e.g., if a CSI RS occasion is not detected during at least one of the first type of time units during the duration of the CSI reference resource. In such implementations, UE 115 may determine, for time units of the first type of time unit during the duration of the CSI reference resource, at least one CSI RS occasion is not received. UE 115 may determine whether the determined number of time units satisfies a threshold. In some implementations, if at least one (e.g., a single, two, three, etc.) time unit of the first type of time unit during the duration does not correspond to a received CSI RS occasion, UE 115 may determine to omit the CSI report. Otherwise, UE 115 may determine to generate and/or transmit CSI report 363.

In yet another example, UE 115 may determine to omit transmission of the CSI report for the CSI target resource. This may occur, for example, if the number CSI RS occasions detected in a first type of time unit of the CSI reference resource having the most detected CSI RS occasions is greater than (or equal to) a third threshold. To illustrate, UE 115 may determine a particular time unit of the first type of time unit (during the duration) during which the most CSI RS occasions were detected. Based on a determination that the number of detected CSI RS occasions for the particular time unit is less than the third threshold, UE 115 may determine to generate and/or transmit CSI report 363. Otherwise, UE 115 may omit (e.g., not generate and/or not send) CSI report 363.

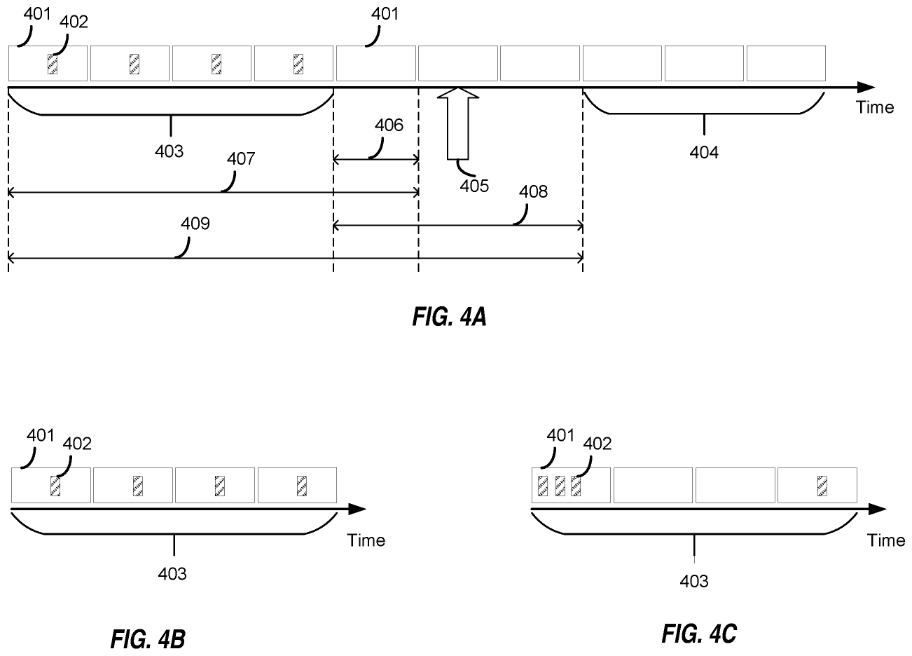

FIG. 4A is a diagram of an example of a CSI reference resource, a CSI target resource, and a CSI report. For example, FIG. 4A graphically illustrates a radio resource configuration in time domain for the CSI reference resource, the CSI target resource, the CSI RS occasions and transmission of the CSI report according to some embodiments of the present disclosure. In an aspect of wireless communication system, radio resource may be configured with a frame structure. For example, 5G NR frame structure may include subframes and/or slots as a unit for radio resource. In an example, the radio resource unit 401 may be a slot in 5G NR. The radio resource unit 401 may also correspond to a time unit. For example, a slot in 5G NR may correspond to 0.5 millisecond in a certain frequency band and may correspond to 0.25 millisecond in another frequency band, as illustrative, non-limiting examples. Radio resource unit 401 may be configured to have CSI RS occasion 402, where base station 105 may transmit CSI RS 362. CSI reference resource 403 may be configured with a plurality of resource units 401 during which UE 115 may monitor CSI RS for predictive CSI estimation for future CSI target resource 404. CSI target resource is later in time than CSI reference resource. UE 115 may be configured by base station 105 to estimate CSI of CSI target resource 404 by monitoring CSI RSs during CSI reference resource 403. UE 115 may send CSI report 405 indicating the estimated CSI of CSI target resource 404. Transmission of the CSI report 405 may be between CSI reference resource 403 and CSI target resource 404.

Configuration information of CSI reference resource may indicate a first time offset between CSI reference resource 403 and transmission of a CSI report 405. In an aspect, the first time offset may be calculated from the end of CSI reference resource 403 to radio resource unit of the CSI report transmission 405 as shown with 406. In another aspect, the first time offset may be calculated from the start of CSI reference resource 403 as shown with 407.

Configuration information of CSI target resource 404 may indicate a second time offset between CSI reference resource 403 and CSI target resource 404. In an aspect, the second time offset may be calculated from the end of CSI reference resource 403 to CSI target resource 404 as shown with 408. In another aspect, the second time offset may be calculated from the start of CSI reference resource 403 as shown with 409. Additionally, or alternatively, a slot offset (or multiple slot offsets) can be defined with respect to the associated CSI resources, or with respect to the last slot of the CSI reference resource, or with respect to absolute slot number. In some implementations, when RRC signaling is used, the CSI-ReportConfig may include or indicate a slot offset (or multiple slot offsets). For example, this could be with respect to the associated CSI resources, or with respect to the last slot of the CSI reference resource, or with respect to absolute slot number.

In some implementations, the CSI reference resource for a serving cell may be defined as the group of downlink physical resource blocks corresponding to the band to which the derived CSI relates. Additionally, or alternatively, the CSI reference resource for a serving cell for a CSI reporting in uplink slot n′ may be defined, in the time domain, by a single or multiple downlink slots in the interval [n−n_{(CS_ref)}−n_{(CSI_span)}, n−n_{(CSI_ref)}]. In such implementations, each CSI RS occasion used to derive CSI report 363 is expected to be received within the CSI reference resource interval.

As described herein, in some implementations, UE 115 is expected to received multiple CSI RS transmission occasions for both channel measurement (CM) and/or channel state information-interference measurement (CSI-IM) within the CSI reference resource. In such implementations, after the CSI report (re)configuration, serving cell activation, bandwidth part (BWP) change, or activation of semi-persistent channel state information (SP-CSI), the UE may transmit a CSI report only after receiving at least X number (e.g., with X being an integer greater than or equal to 1) of CSI-RS transmission occasions for channel measurement and CSI-RS and/or CSI-IM occasion for interference measurement within the CSI reference resource and may omit the report otherwise. When DRX is configured, the UE may transmit a CSI report only if receiving at least X number (e.g., with X greater than or equal to 1) CSI-RS transmission occasions for channel measurement and CSI-RS and/or CSI-IM occasion for interference measurement in DRX Active Time within the CSI reference resource and may omit the report otherwise. If there are less than X valid downlink slots in the CSI reference resource corresponding to a configuration information for CSI reporting in a serving cell, CSI reporting may be omitted for the serving cell in uplink slot n′.

FIG. 4B and FIG. 4C are diagrams illustrating examples of configuration of CSI RS occasions in CSI reference resource are shown. In FIG. 4B, each resource unit 401 of CSI reference resource 403 has a CSI RS occasion 402. Such widely spread CSI RS occasions in CSI reference resources may help UE 115 to perform predictive CSI estimation for future CSI target resource. In some implementations, the CSI RS occasions are evenly spaced. On the other hand, FIG. 4C illustrates an exemplary configuration of CSI reference resource 403 when CSI occasions are concentrated at least one radio resource unit 401. In an aspect, UE 115 may determine to transmit a CSI report for CSI target resource, when CSI reference resource is configured as shown in FIG. 4B. Yet, UE 115 may determine to omit a CSI report for CSI target resource, when CSI reference resource is configured as shown in FIG. 4C.

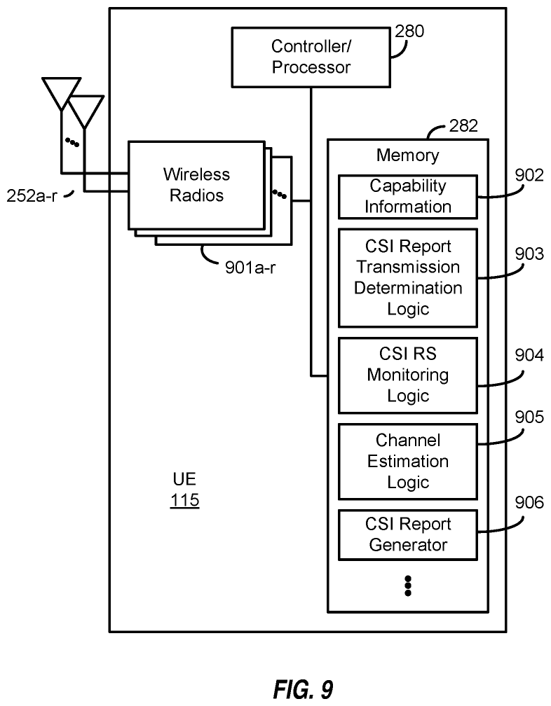

FIGS. 5-7 are flow diagrams illustrating example methods performed by a UE for communication. For example, the example blocks may cause UE to transmit capability information to base station, receive configuration information for CSI reporting, or both, according to some aspects of the present disclosure. The example blocks will also be described with respect to UE 115 as illustrated in FIG. 9. FIG. 9 is a block diagram conceptually illustrating an example design of a UE configured to perform predictive CSI estimation according to one aspect of the present disclosure. UE 115 includes the structure, hardware, and components as illustrated for UE 115 of FIG. 2 or 3. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 901a-r and antennas 252a-r. Wireless radios 901a-r includes various components and hardware, as illustrated in FIG. 2 for UE 115, including modulator/demodulators 254a-r, MIMO detector 256, receive processor 258, transmit processor 264, and TX MIMO processor 266.

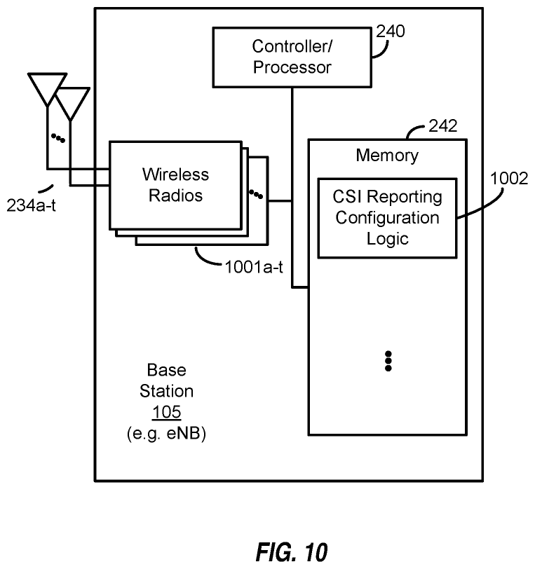

As shown, memory 282 may include capability information 902, CSI report transmission determination logic 903, CSI RS monitoring logic 904, channel estimation logic 905, and CSI report generator 906. Capability information 902, CSI report transmission determination logic 903, CSI RS monitoring logic 904, channel estimation logic 905, and CSI report generator 906 may include or correspond to capability information 306, CSI report transmission determination component 322, CSI RS monitoring component 324, CSI estimation component 326, and CSI report generation component 328, respectively. In some aspects, CSI report transmission determination logic 903, CSI RS monitoring logic 904, channel estimation logic 905 and CSI report generator 906, or a combination thereof, may include or correspond to processor(s) 302. UE 115 may receive signals from and/or transmit signal to a base station, such as base station 105 or base station 105 as illustrated in FIG. 10.

Referring to FIG. 5, a sample flow diagram of UE operations for communication is shown. As illustrated at block 501, a UE transmits capability information of UE for channel state information (CSI) reporting. For example, the capability information may indicate a minimum duration of the CSI reference resource, a maximum time offset between the CSI reference resource and the CSI target resource, a minimum time offset between the CSI reference resource and transmission of a CSI report, or a combination thereof. The capability information may include or correspond to CSI reporting capability message 360 or capability information 902. In some implementations, UE 115 may transmit the capability information using wireless radios 901a-r and antennas 252a-r.

At block 502, the UE receives, from a base station, configuration information for the CSI reporting. The configuration information may indicate the CSI reference resource including a plurality of the first type of time units for CSI reference signal (CSI RS) monitoring, the CSI target resource including one or more of the second type of time units for which channel state information is to be estimated, or both. For example, the configuration may include or correspond to CSI reporting configuration message 361. The first type of time unit may be the same as or different from the second type of time unit. To illustrate, the first type of time unit and the second type of time unit may include a slot, a mini-slot, a subframe, a frame, or a collection of OFDM symbols. For example, the plurality of the first type of time units may be plurality of consecutive slots in the time domain. In some implementations, UE 115 may receive, from base station 105, the configuration information using wireless radios 901a-r and antennas 252a-r.

In some implementations, the configuration information is included in a radio resource control (RRC) message. The configuration information may include a first bitmap representing the plurality of the first type of time units for the CSI reference resource, a second bit map representing one or more of the second type of time units for the CSI target resource, or both. Additionally, or alternatively, the configuration information may indicate a number of CSI-RS occasions to be used to for the channel state information estimation. The number of CSI-RS occasions may include a single occasion or multiple occasions. To illustrate, in a particular implementation, the number of CSI-RS occasions includes multiple occasions. Additionally, or alternatively, the configuration information may indicate the CSI reference resource, a duration of the CSI reference resource, a time offset between the CSI reference resource and transmission of a CSI report, a time offset between the CSI reference resource and a radio frame boundary, the CSI target resource, a duration of the CSI target resource, a time offset between the CSI reference resources and the CSI target resource, or a combination thereof.

Turning to FIG. 6, there is shown another sample flow diagram of UE operations for communication. As illustrated at block 601, a UE determines a duration of the CSI reference resource for CSI RS monitoring. For example, the CSI reference resource may include or correspond to CSI reference resource 403. In some implementations, the CSI reference resource includes a plurality of a first type of time units for CSI reference signal (CSI RS) monitoring. In some implementations, UE 115 may determine a duration of the CSI reference resource using CSI report transmission determination logic 903, CSI RS monitoring logic 904, or both.

At block 602, the UE determines whether to omit transmission of a CSI report indicating channel state information of a CSI target resource. Determinations of whether to send or omit can be based on a number of CSI RS occasions detected during a duration of the CSI reference resource. The CSI report, the CSI target resource, and the CSI RS occasion(s) may include or correspond to CSI report 405, CSI target resource 404, and CSI RS occasion(s) 402. In some implementations, UE 115 may determine whether or not to omit transmission of (or to transmit) the CSI report using CSI report transmission determination logic 903 In an aspect, UE 115 may monitor and count one or more CSI RS occasions 402 during the duration of the CSI reference resource 403 and perform a comparison between the number of detected CSI RS occasions and a first threshold.

In some implementations, the CSI target resource includes one or more of a second type of time units for which channel state information is to be estimated. In some such implementations, the first type of time unit is the same as or different from the second type of time unit. For example, in a particular implementation, the first type and the second type are different. The first type of time unit and the second type of time unit may be a slot, a mini-slot, a subframe, a frame, or a collection of orthogonal frequency-division multiplexing (OFDM) symbols, as illustrative, non-limiting examples. Additionally, or alternatively, the CSI target resource may be later in time as compared to the CSI reference resource, the transmission of the CSI report may be between the CSI reference resource and the CSI target resource in time, or both.

In some implementations, a block may be included in which the UE receives, from a base station (e.g., 105), configuration information for CSI reporting, the configuration information indicating the CSI reference resource, the CSI target resource, or both. To illustrate, UE 115 may receive the configuration information using wireless radios 901a-r and antennas 252a-r. Additionally, or alternatively, one or more blocks may be included in which the UE detects one or more CSI RS occasions during the duration of the CSI reference resource, and determines the number of the one or more detected CSI RS occasions. To illustrate, UE 115 may receive the one or more CSI RS occasions using wireless radios 901a-r and antennas 252a-r. Additionally, in some implementations, UE 115 may detect the number of CSI RS occasions and/or determine the number of the one or more detected CSI RS occasions using CSI RS monitoring logic 904.

In some implementations, determining whether to omit transmission of the CSI report may include a block in which the UE determines to omit transmission of the CSI report for the CSI target resource based on a result of a comparison indicating that the number of the detected CSI RS occasions is less than or equal to a first threshold. To illustrate, in some implementations, a block may be included in which the UE monitors, during the duration of the CSI reference resource, for one or more CSI RS occasions, and determines, based on monitoring for the one or more CSI RS occasions, the number of CSI RS occasions detected during the duration of the CSI reference resource. The UE may perform a first comparison between the number of detected CSI RS occasions and a first threshold.

Additionally, or alternatively, a block may be included in which the UE determines a number of the first type of time units of the CSI reference resource during which one or more CSI RS occasions were detected, performs a comparison between the number of the first type of time units and a second threshold. In some such implementations, UE determines to omit transmission of the CSI report for the CSI target resource based on a result of the second comparison indicating that the number of the first type of time units is less than the second threshold.

In some implementations, a block may be included in which the UE determines whether at least one CSI RS occasion is detected during each the first type of time unit of the CSI reference resource. In some such implementations, the UE may determine to omit transmission of the CSI report for the CSI target resource based on a determination that a CSI RS occasion is not detected during at least one of the first type of time units of the CSI reference resource. In situations where UE determines to omit transmission, the UE may or may not generate the CSI report. If the UE generates the CSI report and determines to omit transmission of the CSI report, the UE may discard the generated CSI report.

In some implementations, determining whether to omit transmission of the CSI report may include a block in which the UE determines to transmit the CSI report for the CSI target resource based on a result of a comparison indicating that the number of detected CSI RS occasions is greater than or equal to a first threshold. In some such implementations, a block may be included in which the UE estimates, based on at least one CSI RS occasion detected during the duration of the CSI reference resource, the channel state information for the one or more of the second type of time units of the CSI target resource. To illustrate, UE 115 may estimate the channel state information using channel estimation logic 905. In some implementations, a block may be included in which the UE may generating the CSI report indicating the channel state information for the one or more of the second type of time units of the CSI target resource. For example, UE 115 may generate the CSI report using CSI report generator 906. UE may transmit the CSI report to one or more other devices, such a base station. To illustrate, UE 115 may transmit the CSI report using wireless radios 901a-r and antennas 252a-r.

In some implementations, determining whether or not to omit transmission of (or to transmit) the CSI report for the CSI target resource may be based on a number of the first type of time units of the CSI reference resource during which one or more CSI RS occasions were detected, a number CSI RS occasions detected in a first type of time unit of the CSI reference resource having the most detected CSI RS occasions, whether at least one CSI RS occasion is detected during each first type of time unit of the CSI reference resource, or a combination thereof.

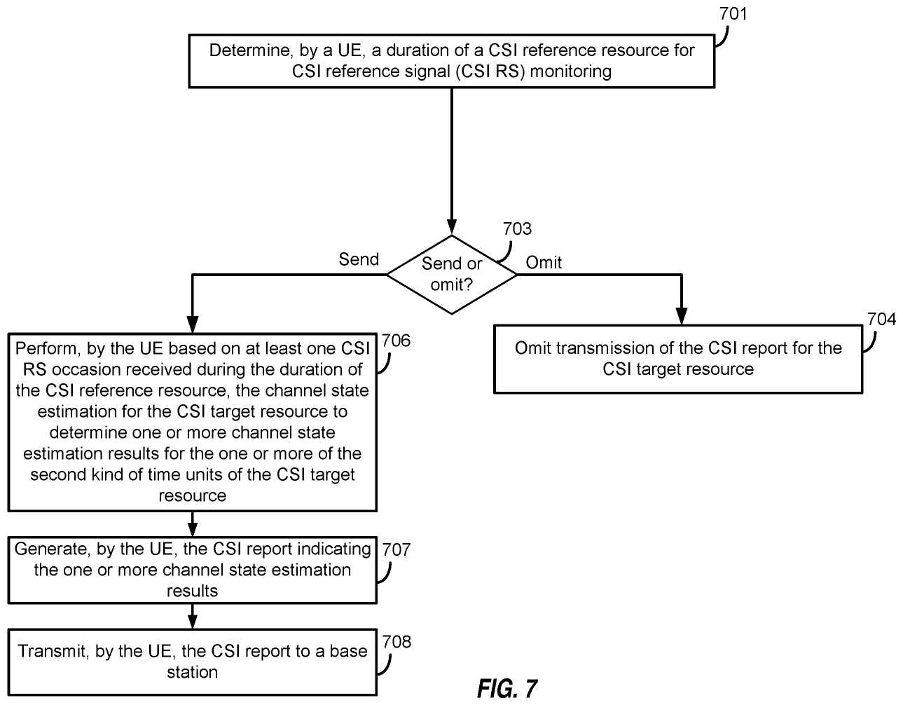

Turning to FIG. 7, there is shown another sample flow diagram of UE operations for communication. As illustrated at block 701, a UE determines a duration of the CSI reference resource for CSI RS monitoring. For example, the CSI reference resource may include or correspond to CSI reference resource 403. In some implementations, UE 115 may determine the duration of the CSI reference resource using CSI report transmission determination logic 903, CSI RS monitoring logic 904, or both.

At block 703, the UE determines whether to omit transmission of (or to transmit) a CSI report. For example, the CSI report may include or correspond to CSI report 405 indicating channel state information of a CSI target resource 404, based on a number of CSI RS occasions 402 detected during the duration of the CSI reference resource 403. In an aspect, UE may monitor and count one or more CSI RS occasions (e.g., 402) during the duration of the CSI reference resource 403 and perform a comparison between the number of detected CSI RS occasions and a first threshold. In some implementations, UE 115 determines whether to omit transmission of (or to transmit) the CSI report using CSI report transmission determination logic 903.

In some implementations, the UE may determine to omit transmission of the CSI report based on, for example, a result of a comparison indicating that the number of the detected CSI RS occasions is less than (or equal to) the first threshold. Alternatively, the UE may determine to transmit the CSI report for the CSI target resource based on, for example, the result of the comparison indicating that the number of detected CSI RS occasions is greater than (or equal to) the first threshold.

Based on a determination to omit transmission of the CSI report, UE omits transmission of the CSI report, at block 704. Alternatively, based on a determination to transmit the CSI report, UE estimates, at block 706, the channel state information for the one or more of the second type of time units of the CSI target resource based on at least one CSI RS occasion detected during the duration of the CSI reference resource. In some implementations, UE 115 estimates the channel state information using channel estimation logic 905.

At block 707, UE may generate the CSI report indicating the one or more channel state information for the second type of time units of the CSI target resource. To illustrate, UE 115 may generate the CSI report using CSI report generator 906. At block 706, the UE transmits the CSI report. For example, the UE may transmit the CSI report to a base station (e.g., 105). In some implementations, UE 115 may transmit the CSI report using wireless radios 901a-r and antennas 252a-r.

It is noted that one or more blocks (or operations) described with reference to FIGS. 5-7 may be combined with one or more blocks (or operations) of another of figure. For example, one or more blocks of FIG. 5, 6, or 7 may be combined with one or more blocks (or operations) of another of FIG. 2, 3, 5-7, or 9. Additionally, or alternatively, one or more operations described above with reference to FIGS. 1-3 may be combine with one or more operations described with reference to FIG. 9.

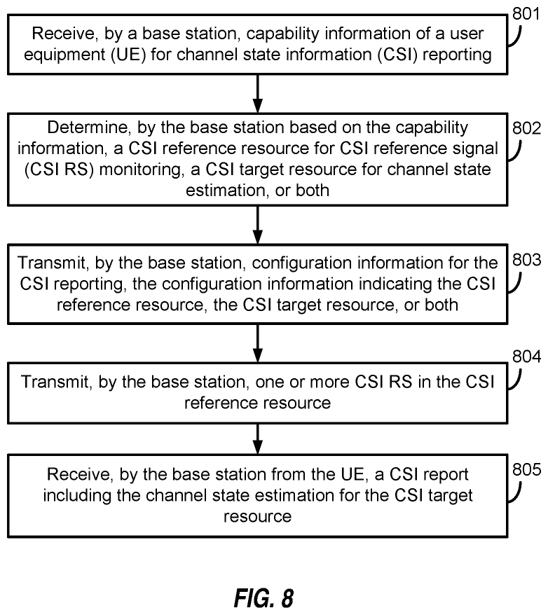

FIG. 8 is a flow diagram illustrating an example method performed by a base station to receive a predictive CSI from a UE. The example blocks will also be described with respect to base station 105 as illustrated in FIG. 10, which may include or correspond to base station 105 of FIG. 3. FIG. 10 is a block diagram conceptually illustrating an example design of a base station 105 configured to configure UE 115 to perform predictive CSI estimation according to some embodiments of the present disclosure.

Base station 105 includes the structure, hardware, and components as illustrated for base station 105 of FIG. 2 or 3. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1001a-t and antennas 234a-t. Wireless radios 1001a-t includes various components and hardware, as illustrated in FIG. 2 for base station 105, including modulator/demodulators 232a-t, transmit processor 220, TX MIMO processor 230, MIMO detector 236, and receive processor 238. As shown, memory 242 may include CSI reporting configuration logic 1002. CSI reporting configuration logic 1002 may include or correspond to message generator 338. In some aspects, CSI reporting configuration logic 1002 may include or correspond to processor(s) 302. Base station 105 may receive signals from and/or transmit signal to a UE, such as UE 115 as illustrated in FIG. 6.

Turning to FIG. 8, a sample flow diagram of base station operations for communication is shown. As illustrated at block 801, a base station receives a CSI reporting capability message including capability information of a UE for channel state information (CSI) reporting. For example, the CSI reporting capability message and the capability information may include or correspond to CSI reporting capability message 360 and capability information 306, respectively. In some implementations, the base station 105 may receive the CSI reporting capability message using wireless radios 1001a-t and antennas 234a-t.

At block 802, the base station determines, based on the capability information, the CSI reference resource, the CSI target resource, or both. In some implementations, the base station 105 may determine the CSI reference resource, the CSI target resource, or both, using CSI reporting configuration logic 1002.

At block 803, the base station transmits a CSI reporting configuration message including configuration information for the CSI reporting. For example, the CSI reporting configuration message may include or correspond to CSI reporting configuration message 361. The configuration information may indicate the CSI reference resource, the CSI target resource, or both. In some implementations, the base station 105 may transmit the CSI reporting configuration message using wireless radios 1001a-t and antennas 234a-t.

At block 804, the base station transmits one or more CSI RSs in the CSI reference resource. For example, the one or more CSI RSs may include or correspond to CSI RS(s) 362. In some implementations, the base station 105 may transmit the one or more CSI RSs using wireless radios 1001a-t and antennas 234a-t.

At block 805, the base station receives, from the UE, a CSI report indicating the channel state information for the CSI target resource. The CSI report may include or correspond to CSI report 363. In some implementations, the base station 105 may receive the CSI report using wireless radios 1001a-t and antennas 234a-t.

It is noted that one or more blocks (or operations) described with reference to FIG. 8 may be combined with one or more blocks (or operations) of another of figure. For example, one or more blocks of FIG. 8 may be combined with one or more blocks (or operations) of another of FIG. 2, 3, or 10. Additionally, or alternatively, one or more operations described above with reference to FIGS. 1-3 may be combine with one or more operations described with reference to FIG. 10.

In some aspects, configuration and/or use of a CSI reference resource, a CSI target resource, or both may include a wireless receiving device transmitting capability information of the wireless receiving device for channel state information (CSI) reporting. Configuration and/or use of a CSI reference resource, a CSI target resource, or both of aspects may further include the wireless receiving device receiving, from a base station, configuration information for the CSI reporting. The configuration information may indicate a CSI reference resource comprising a plurality of a first type of time units for CSI reference signal (CSI RS) monitoring, a CSI target resource comprising one or more of a second type of time units for which channel state information is to be estimated, or both. The CSI target resource may be later in time compared to the CSI reference resource.

Additionally, or alternatively, some aspects, configuration and/or use of a CSI reference resource, a CSI target resource, or both may include the wireless receiving device determining a duration of a channel state information (CSI) reference resource. The CSI reference resource may include a plurality of a first type of time units for CSI reference signal (CSI RS) monitoring. Configuration and/or use of a CSI reference resource, a CSI target resource, or both of aspects may further include the wireless receiving device determining whether to omit transmission of a CSI report indicating channel state information of a CSI target resource based on a number of CSI reference signal (CSI RS) occasions detected during the duration of the CSI reference resource. The CSI target resource may include one or more of a second type of time units for which channel state information is to be estimated, the CSI target resource may be later in time as compared to the CSI reference resource, the transmission of the CSI report may be between the CSI reference resource and the CSI target resource in time, or a combination thereof.

Configuration and/or use of a CSI reference resource, a CSI target resource, or both may include additional aspects, such as any single aspect or any combination of aspects described below and/or in connection with one or more other processes described elsewhere herein.

In a first aspect, the first type of time unit is the same as the second type of time unit.

In a second aspect, the first type of time unit is different from the second type of time unit.

In a third aspect, alone or in combination with one or more of the first and second aspects, the wireless receiving device receives the first type of time unit and the second type as at least one of a slot, a mini-slot, a subframe, a frame, or a collection of orthogonal frequency-division multiplexing (OFDM) symbols.

In a fourth aspect, alone or in combination with one or more of the first through third aspects, the wireless receiving device receives the configuration information is included in a radio resource control (RRC) message.

In a fifth aspect, alone or in combination with one or more of the first through fourth aspects, the wireless receiving device receives the configuration information as a first bitmap representing the plurality of the first type of time units for the CSI reference resource, a second bit map representing one or more of the second type of time units for the CSI target resource, or both.

In a sixth aspect, alone or in combination with one or more of the first through fifth aspects, the capability information indicates a minimum duration of the CSI reference resource.

In a seventh aspect, alone or in combination with one or more of the first through sixth aspects, the capability information indicates a maximum time offset between the CSI reference resource and the CSI target resource.

In an eighth aspect, alone or in combination with one or more of the first through seventh aspects, the capability information indicates a minimum time offset between the CSI reference resource and transmission of a CSI report.

In a ninth aspect, alone or in combination with one or more of the first through eighth aspects, the configuration information further indicates a number of CSI-RS occasions to be used to for the channel state information estimation, and the number of CSI-RS occasions comprises a single occasion or multiple occasions.

In a tenth aspect, in combination with the ninth aspect, the number of CSI-RS occasions comprises multiple occasions.

In an eleventh aspect, alone or in combination with one or more of the first through tenth aspects, the configuration information indicates the CSI reference resource; and the plurality of the first type of time units comprise a plurality of consecutive slots in the time domain.

In a twelfth aspect, alone or in combination with one or more of the first through eleventh aspects, the configuration information indicates the CSI reference resource and a duration of the CSI reference resource.

In a thirteenth aspect, alone or in combination with one or more of the first through twelfth aspects, the configuration information indicates the CSI reference resource and a time offset between the CSI reference resource and transmission of a CSI report.

In a fourteenth aspect, alone or in combination with one or more of the first through thirteenth aspects, the configuration information indicates the CSI reference resource and a time offset between the CSI reference resource and a radio frame boundary.

In a fifteenth aspect, alone or in combination with one or more of the first through fourteenth aspects, the configuration information indicates the CSI target resource, and a duration of the CSI target resource, a time offset between the CSI reference resources and the CSI target resource, or both.

In a sixteenth aspect, alone or in combination with one or more of the first through fifteenth aspects, the wireless receiving device receives configuration information for CSI reporting, the configuration information indicating the CSI reference resource, the CSI target resource, or both.

In a seventeenth aspect, alone or in combination with one or more of the first through sixteenth aspects, the wireless receiving device detects one or more CSI RS occasions during the duration of the CSI reference resource.

In an eighteenth aspect, in combination with the seventeenth aspects, the wireless receiving device determines the number of the one or more detected CSI RS occasions.

In a nineteenth aspect, alone or in combination with one or more of the first through eighteenth aspects, where determining whether to omit transmission of the CSI report includes the wireless receiving device determining to omit transmission of the CSI report for the CSI target resource based on a result of a comparison indicating that the number of the detected CSI RS occasions is less than or equal to a first threshold.

In a twentieth aspect, alone or in combination with one or more of the first through nineteenth aspects, the wireless receiving device monitors, during the duration of the CSI reference resource, for one or more CSI RS occasions.

In a twenty-first aspect, alone or in combination with one or more of the first through twentieth aspects, the wireless receiving device determines, based on monitoring for the one or more CSI RS occasions, the number of CSI RS occasions detected during the duration of the CSI reference resource.

In a twenty-second aspect, alone or in combination with one or more of the first through twenty-first aspects, the wireless receiving device performs a first comparison between the number of detected CSI RS occasions and a first threshold.

In a twenty-third aspect, alone or in combination with one or more of the first through twenty-second aspects, the wireless receiving device determines a number of the first type of time units of the CSI reference resource during which one or more CSI RS occasions were detected

In a twenty-fourth aspect, alone or in combination with one or more of the first through twenty-third aspects, the wireless receiving device performs a second comparison between the number of the first type of time units and a second threshold.

In a twenty-fifth aspect, alone or in combination with one or more of the first through twenty-third aspects, the wireless receiving device determines to omit transmission of the CSI report for the CSI target resource based on a result of the second comparison indicating that the number of the first type of time units is less than the second threshold.

In a twenty-sixth aspect, alone or in combination with one or more of the first through twenty-fifth aspects, the wireless receiving device determines whether at least one CSI RS occasion is detected during each the first type of time unit of the CSI reference resource.

In a twenty-seventh aspect, alone or in combination with one or more of the first through twenty-sixth aspects, the wireless receiving device determines to omit transmission of the CSI report for the CSI target resource based on a determination that a CSI RS occasion is not detected during at least one of the first type of time units of the CSI reference resource.

In a twenty-eighth aspect, alone or in combination with one or more of the first through eighteenth aspects, determining whether to omit transmission of the CSI report includes the wireless receiving device determining to transmit the CSI report for the CSI target resource based on a result of a comparison indicating that the number of detected CSI RS occasions is greater than or equal to a first threshold.

In a twenty-ninth aspect, in combination with the twenty-eighth aspect, the wireless receiving device estimates, based on at least one CSI RS occasion detected during the duration of the CSI reference resource, where the channel state information for the one or more of the second type of time units of the CSI target resource.

In a thirtieth aspect, alone or in combination with one or more of the twenty-eighth through twenty-ninth aspects, the wireless receiving device generates the CSI report indicating the channel state information for the one or more of the second type of time units of the CSI target resource.

In a thirty-first aspect, alone or in combination with one or more of the twenty-eighth through thirtieth aspects, the wireless receiving device transmits the CSI report.

In a thirty-second aspect, alone or in combination with one or more of the first through thirty-first aspects, where determining whether to omit transmission of the CSI report for the CSI target resource is further based on a number of the first type of time units of the CSI reference resource during which one or more CSI RS occasions were detected, a number CSI RS occasions detected in a first type of time unit of the CSI reference resource having the most detected CSI RS occasions, whether at least one CSI RS occasion is detected during each first type of time unit of the CSI reference resource, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIGS. 2 and 3) may include processors, electronics devices, hardware devices, electronics components, logical circuits, memories, software codes, firmware codes, etc., or any combination thereof. In addition, features discussed herein relating to FIGS. 2, 3, and 5-8 may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 5-8) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, the method comprising:
transmitting, by a user equipment (UE), capability information of the UE for channel state information (CSI) reporting; and
receiving, by the UE from a base station, configuration information for the CSI reporting, the configuration information indicating a CSI reference resource comprising a plurality of a first type of time units for CSI reference signal (CSI RS) monitoring, a CSI target resource comprising one or more of a second type of time units for which channel state information is to be estimated, or both, wherein the CSI target resource is later in time compared to the CSI reference resource.

2. The method of claim 1, wherein the first type of time unit is the same as or different from the second type of time unit.

3. The method of claim 1, wherein the first type of time unit is different from the second type of time unit.

4. The method of any of claims 1-3, further comprising receiving the first type of time unit and the second type of time unit as at least one of a slot, a mini-slot, a subframe, a frame, or a collection of orthogonal frequency-division multiplexing (OFDM) symbols.

5. The method of any of claims 1-4, further comprising receiving the configuration information in a radio resource control (RRC) message.

6. The method of any of claims 1-5, further comprising receiving the configuration information as a first bitmap representing the plurality of the first type of time units for the CSI reference resource, a second bit map representing one or more of the second type of time units for the CSI target resource, or both.

7. An apparatus for wireless communication, the apparatus comprising:
at least one processor; and
a memory coupled to the at least one processor,
wherein the at least one processor is configured to:
initiate, by a user equipment (UE), transmission of capability information of the UE for channel state information (CSI) reporting; and
receive, by the UE from a base station, configuration information for the CSI reporting, the configuration information indicating a CSI reference resource comprising a plurality of a first type of time units for CSI reference signal (CSI RS) monitoring, a CSI target resource comprising one or more of a second type of time units for which channel state information is to be estimated, or both, and wherein the CSI target resource is later in time compared to the CSI reference resource.

8. The apparatus of claim 7, wherein the capability information indicates a minimum duration of the CSI reference resource.

9. The apparatus of any of claims 7-8, wherein the capability information indicates a maximum time offset between the CSI reference resource and the CSI target resource.

10. The apparatus of any of claims 7-9, wherein the capability information indicates a minimum time offset between the CSI reference resource and transmission of a CSI report.

11. The apparatus of any of claims 7-10, wherein the configuration information further indicates a number of CSI-RS occasions to be used to for the channel state information estimation, and the number of CSI-RS occasions comprises a single occasion or multiple occasions.

12. The apparatus of claim 11, wherein the number of CSI-RS occasions comprises multiple occasions.

13. The apparatus of any of claims 7-12, wherein:
the configuration information indicates the CSI reference resource; and
the plurality of the first type of time units comprise a plurality of consecutive slots in the time domain.

14. The apparatus of any of claims 7-13, wherein the configuration information indicates the CSI reference resource and a duration of the CSI reference resource.

15. The apparatus of any of claims 7-14, wherein the configuration information indicates the CSI reference resource and a time offset between the CSI reference resource and transmission of a CSI report.

16. The apparatus of any of claims 7-15, wherein the configuration information indicates the CSI reference resource and a time offset between the CSI reference resource and a radio frame boundary.

17. The apparatus of any of claims 7-16, wherein the configuration information indicates the CSI target resource, and a duration of the CSI target resource, a time offset between the CSI reference resources and the CSI target resource, or both.

18. A method for wireless communication, the method comprising:
determining, by a user equipment (UE), a duration of a channel state information (CSI) reference resource, the CSI reference resource comprises a plurality of a first type of time units for CSI reference signal (CSI RS) monitoring; and
determining, by the UE, whether to transmit or omit transmission of a CSI report indicating channel state information of a CSI target resource based on a number of CSI reference signal (CSI RS) occasions detected during the duration of the CSI reference resource; and
wherein:
the CSI target resource comprises one or more of a second type of time units for which channel state information is to be estimated;
the CSI target resource is later in time as compared to the CSI reference resource; and
the transmission of the CSI report is between the CSI reference resource and the CSI target resource in time.

19. The method of claim 18, further comprising:
receiving, by the UE from a base station, configuration information for CSI reporting, the configuration information indicating the CSI reference resource, the CSI target resource, or both.

20. The method of any of claims 18-19, further comprising:
detecting one or more CSI RS occasions during the duration of the CSI reference resource; and
determining the number of the one or more detected CSI RS occasions.

21. The method of any of claims 18-20, wherein determining, by the UE, whether to omit transmission of the CSI report comprises determining, by the UE, to omit transmission of the CSI report for the CSI target resource based on a result of a comparison indicating that the number of the received CSI RS occasions is less than or equal to a first threshold.

22. The method of any of claims 18-21, further comprising:
monitoring, by the UE during the duration of the CSI reference resource, for one or more CSI RS occasions;
determining, by the UE based on monitoring for the one or more CSI RS occasions, the number of CSI RS occasions received during the duration of the CSI reference resource; and
performing, by the UE, a first comparison between the number of received CSI RS occasions and a first threshold.

23. The method of any of claims 18-22, further comprising:
determining, by the UE, a number of the first type of time units of the CSI reference resource during which one or more CSI RS occasions were detected;
performing, by the UE, a second comparison between the number of the first type of time units and a second threshold; and
determining, by the UE, to omit transmission of the CSI report for the CSI target resource based on a result of the second comparison indicating that the number of the first type of time units is less than the second threshold.

24. The method of any of claims 18-23, further comprising:
determining, by the UE, whether at least one CSI RS occasion is detected during each the first type of time unit of the CSI reference resource; and
determining, by the UE, to omit transmission of the CSI report for the CSI target resource based on a determination that a CSI RS occasion is not detected during at least one of the first type of time units of the CSI reference resource.

25. The method of any of claims 18-22, wherein determining, by the UE, whether to omit transmission of the CSI report comprises determining, by the UE, to transmit the CSI report for the CSI target resource based on a result of a comparison indicating that the number of detected CSI RS occasions is greater than or equal to a first threshold, and further comprising:
estimating, by the UE based on at least one CSI RS occasion detected during the duration of the CSI reference resource, the channel state information for the one or more of the second type of time units of the CSI target resource;
generating, by the UE, the CSI report indicating the channel state information for the one or more of the second type of time units of the CSI target resource; and
transmitting, by the UE, the CSI report to a base station.

26. The method any of claims 18-25, wherein determining, by the UE, whether to omit transmission of the CSI report for the CSI target resource is further based on a number of the first type of time units of the CSI reference resource during which one or more CSI RS occasions were detected, a number CSI RS occasions detected in a first type of time unit of the CSI reference resource having the most detected CSI RS occasions, whether at least one CSI RS occasion is detected during each first type of time unit of the CSI reference resource, or a combination thereof.

27. An apparatus for wireless communication, the apparatus comprising:
at least one processor; and
a memory coupled to the at least one processor,
wherein the at least one processor is configured to:
determine, by a user equipment (UE), a duration of a channel state information (CSI) reference resource that comprises a plurality of a first type of time units for CSI reference signal (CSI RS) monitoring; and
determine, by the UE, whether to omit transmission of a CSI report indicating channel state information of a CSI target resource based on a number of CSI reference signal (CSI RS) occasions detected during the duration of the CSI reference resource; and
wherein:
the CSI target resource comprises one or more of a second type of time units for which channel state information is to be estimated;
the CSI target resource is later in time as compared to the CSI reference resource; and
the transmission of the CSI report is between the CSI reference resource and the CSI target resource in time.

28. The apparatus of claim 27, wherein the first type of time unit is the same as the second type of time unit.

29. The apparatus of claim 27, wherein the first type of time unit is different from the second type of time unit.

30. The apparatus of claim 27, wherein the first type of time unit and the second type of time unit comprise a slot, a mini-slot, a subframe, a frame, or a collection of orthogonal frequency-division multiplexing (OFDM) symbols.
